(19) United States
(12) Patent Application Publication
(10) Pub. No.: US 2014/0220423 A1
(43) Pub. Date: Aug. 7, 2014

(54) BATTERY PACK

(71) Applicant: SAMSUNG SDI CO., LTD., Yongin-si (KR)

(72) Inventors: Sang-Il YI, Yongin-si (KR); Choong-Hoon LEE, Yongin-si (KR)

(21) Appl. No.: 13/941,718

(22) Filed: Jul. 15, 2013

(30) Foreign Application Priority Data
Feb. 5, 2013 (KR) 10-2013-0012885

(51) Int. Cl. H01M 2/02

(52) U.S. Cl. CPC H01M 2/02; H01M 2/0202; H01M 2/0237
USPC 429/163

(57) ABSTRACT

A battery pack includes a bare cell and a case portion accommodating the bare cell therein. The case portion includes a metal portion and an insulation portion covering at least one portion of the metal portion. The metal portion includes an irregularity portion.

### CROSS-REFERENCE TO RELATED APPLICATION

This application claims priority under 35 U.S.C. §119 to and the benefit of

Korean Patent Application No. 10-2013-0012885, filed on Feb. 5, 2013, in the Korean Intellectual Property Office, the entire content of which is incorporated herein by reference.

### BACKGROUND

1. Field

Embodiments relate to a battery pack.

2. Description of the Related Art

Recently, secondary batteries have been variously used as power sources of portable electronic devices. As the portable electronic devices are used in various fields, demands on secondary batteries are rapidly increasing. The secondary batteries can be charged/discharged a plurality of times and, accordingly, are economically and environmentally efficient. Thus, the use of battery packs is encouraged.

As the small size and light weight of electronic devices are required, the small size and light weight of secondary batteries are also required. However, since a material, e.g., lithium, having high reactivity is provided inside of the secondary battery, the small size and light weight of the secondary battery is limited due to safety concerns of the secondary battery. Accordingly, a variety of studies have been conducted to develop a battery pack that can implement as a small and light battery pack while improving the safety of the secondary battery.

### SUMMARY

At least one embodiment is recited to providing a battery pack, including a bare cell and a case portion accommodating the bare cell therein. The case portion may include a metal portion and an insulation portion covering at least one portion of the metal portion, wherein the metal portion includes an irregularity portion.

The irregularity portion may be formed in a region of the metal portion contacting the insulation portion.

The insulation portion may be coupled to the metal portion so that at least one portion of the insulation portion is filled in the irregularity portion of the metal portion.

The insulation portion may include an inner insulation portion covering an inner portion of the metal portion and an edge insulation portion covering an edge portion of the metal portion.

The battery pack may further include a protective circuit module connected to the bare cell and mounted on the inner insulation portion.

The irregularity portion may be formed at the inner portion of the metal portion.

The edge portion of the metal portion may be bent.

The edge portion may be bent two or more times.

The edge portion may be bent toward the inside of the metal portion, i.e., towards the battery cell.

The edge portion may be bent toward the outside of the metal portion, i.e., away from the battery cell.

A plurality of coupling elements, e.g., holes, may be formed in the edge portion, and the edge insulation portion may cover the edge portion so that at least one portion of the edge portion fills in the coupling elements.

A plurality of prominences may be formed on the irregularity portion.

The case portion may further include an insulation treatment layer positioned at the metal portion exposed to the outside.

The insulation treatment layer may be coupled to the metal portion so that at least one portion of the insulation treatment layer fills in the irregularity portion of the metal portion.

The insulation portion may be formed through insert injection molding.

### BRIEF DESCRIPTION OF THE DRAWINGS

Features will become apparent to those of ordinary skill in the art by describing in detail exemplary embodiments with reference to the attached drawings in which:

FIG. 1 illustrates a perspective view of a battery pack according to an embodiment.

FIG. 2 illustrates an exploded perspective view of the battery pack shown in FIG. 1.

FIG. 3 illustrates a perspective view of a case portion of the battery pack shown in FIG. 1.

FIG. 4 illustrates a perspective view of a metal portion in the case portion shown in FIG. 3.

FIG. 5 illustrates a schematic enlarged view of an irregularity portion of the metal portion shown in FIG. 4.

FIG. 6 illustrates a perspective view of a metal portion of the battery pack according to another embodiment.

FIGS. 7 and 8 illustrate perspective views of metal portions of the battery pack according to still other embodiments.

FIG. 9 illustrates an exploded perspective view of a battery pack according to still another embodiment.

FIG. 10 illustrates a perspective view of a metal portion of the battery pack shown in FIG. 9.

FIG. 11 illustrates a schematic enlarged view of an irregularity portion of a metal portion in a battery pack according to still another embodiment.

### DETAILED DESCRIPTION

Korean Patent Application No. 10-2013-0012885, filed on Feb. 5, 2013, in the Korean Intellectual Property Office, and entitled: “Battery pack” is incorporated by reference herein in its entirety.

In the following detailed description, only certain exemplary embodiments of have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. In addition, when an element is referred to as being “on” another element, it can be directly on another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

Terms or words used in this specification and claims should not be restrictively interpreted as ordinary meanings or dictionary-based meanings, but should be interpreted as meanings and concepts conforming to the scope of the present disclosure on the basis of the principle that an inventor can properly define the concept of a term.

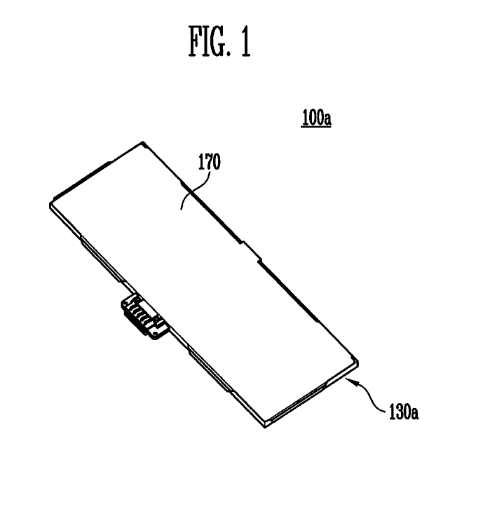

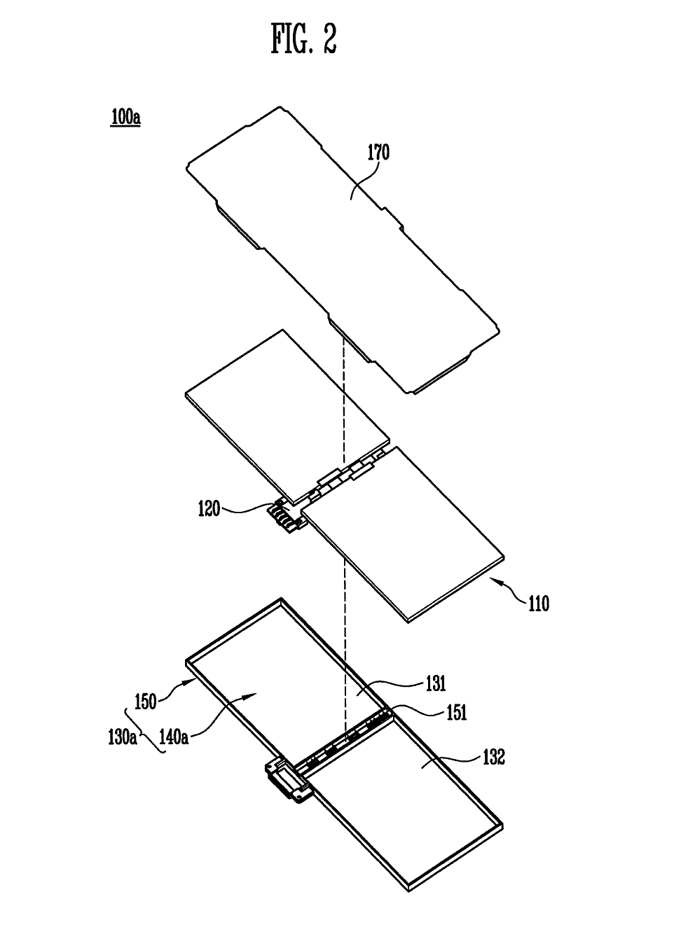

FIG. 1 illustrates a perspective view of a battery pack 100a according to an embodiment. FIG. 2 illustrates an exploded perspective view of the battery pack 100a shown in FIG. 1. Hereinafter, the battery pack 100a according to this embodiment will be described with reference to FIGS. 1 and 2.

As shown in FIGS. 1 and 2, the battery pack 100a according to this embodiment includes a bare cell 110, a protective circuit module 120, and a case portion 130a accommodating the bare cell 110 and the protective circuit module 120 therein. The case portion 130a may include a metal portion 140a and an insulation portion 150.

The bare cell 110 is a member that generates electrochemical energy by the movement of ions or electrons. A plurality of bare cells may be aligned.

The bare cell 110 may be manufactured by accommodating an electrode assembly and an electrolyte in a battery case. In this case, the electrode assembly is formed by winding or stacking a positive electrode plate, a negative electrode plate, and a separator interposed between these electrode plates. The electrode assembly generates energy through an electrochemical reaction between the electrode assembly and the electrolyte, and the energy is supplied to the outside of the bare cell through an electrode tab or the like. The battery case may have a variety of shapes, e.g., pouch shape, prismatic shape, or cylindrical shape.

A plurality of bare cells 110 may be aligned. For example, the bare cells 110 may be respectively positioned in first and second regions 131 and 132 divided by an inner insulation portion 151 in the case portion 130a.

The protective circuit module 120 is a member that controls voltage or current when the bare cell 110 is charged and discharged. The protective circuit module 120 may be positioned on the inner insulation portion 151 in the case portion 130a. The protective circuit module 120 is connected to all the bare cells 110 respectively positioned in the first and second regions 131 and 132, thereby controlling the bare cells 110.

The protective circuit module 120 may be implemented as a circuit board having a circuit pattern formed thereon, and several electronic components may be mounted on one surface of the protective circuit module 120. The electronic components may be a field effect transistor (FET), integrated circuit (IC), positive temperature coefficient (PCT), etc. The electronic components may perform a function of controlling the electrode assembly in the bare cell 110 or cutting off a circuit when the electrode assembly is abnormally operated. The circuit board of the protective circuit module 120 may include a switching circuit to more efficiently control or protect the battery pack 100a together with the electronic components. In an implementation, the protective circuit module 120 blocks overcharging, over discharging, overcurrent, short circuit, and reverse voltage of the battery pack 100a, in order to reduce or prevent undesirable conditions, e.g., explosion, overheat, leakage, and/or deterioration of charging/discharging characteristics of the battery pack 100a, and to restrain the degradation of electrical performance and abnormal operation. Accordingly, safety and lifetime of the battery pack 100a may be increased.

A label 170 is a member that surrounds the outside of the case portion 130 in which the bare cell 110 and the protective circuit module 120 are accommodated. The label 170 may be implemented to surround not only a surface of the case portion 130, but also surfaces of the bare cell 110 and the protective circuit module 120, which are exposed to the outside. Information regarding the battery pack 100a may be printed on a surface of the label 170.

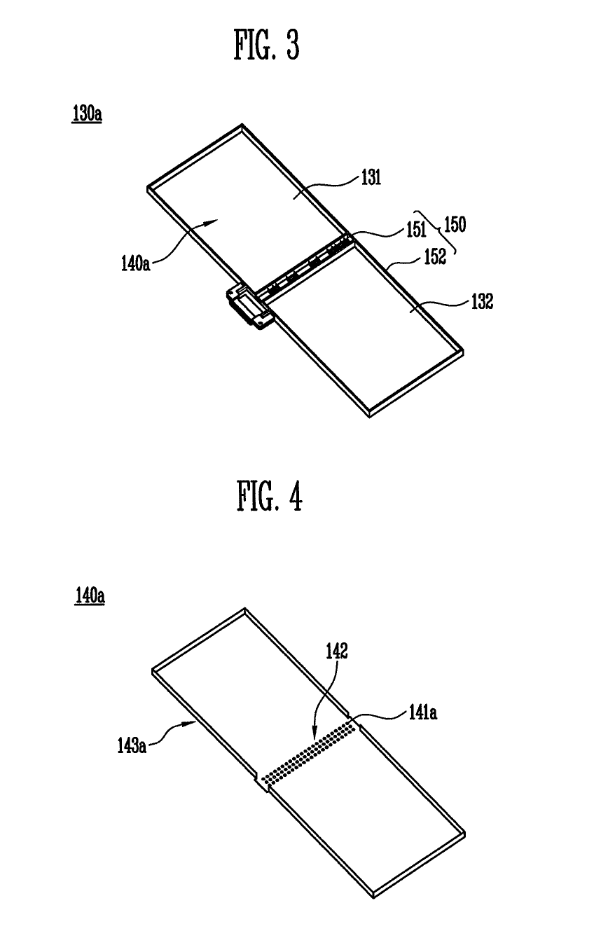

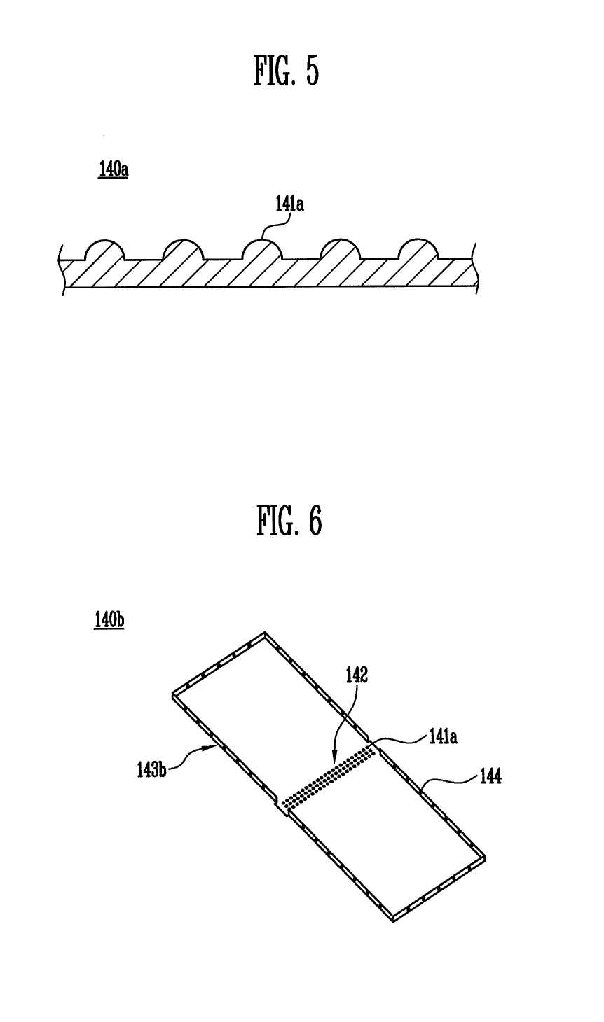

FIG. 3 illustrates a perspective view of the case portion 130a of the battery pack 100a shown in FIG. 1. FIG. 4 illustrates a perspective view of the metal portion 140a in the case portion 130a shown in FIG. 3. FIG. 5 illustrates a schematic enlarged view of an irregularity portion 141a of the metal portion 140a shown in FIG. 4. Hereinafter, the case portion 130a according to this embodiment will be described with reference to FIGS. 3 to 5.

As shown in FIGS. 3 and 4, the case portion 130a according to this embodiment is a member that accommodates the bare cell 110 therein. The case portion 130a may include the metal portion 140a and an insulation portion 150 covering at least one portion of the metal portion 140a.

The metal portion 140a is a member that secures hardness of the case portion 130a, and may include an irregularity portion 141a. Specifically, the metal portion 140a may include the irregularity portion 141a formed at an inner portion 142 that is a region contacting the insulation portion 150. As will be apparent to one of ordinary skill in the art from the following description and drawings, the irregularity portion may be any suitable portion that deviates from a smooth surface, i.e., increases a surface area of the metal portion. Accordingly, it is possible to solidify the coupling between the insulation portion 150 and the metal portion 140a, which are made of different materials.

When the insulation portion 150 is manufactured using an insert injection molding method in which the metal portion 140a is inserted and then injection-molded, a portion of the insulation portion 150 is filled in a recessed portion of the irregularity portion 141a formed at the inner portion 142, so that the coupling between the insulation portion 150 and the metal portion 140a can be solidified. When the irregularity portion 141a is present, the surface area of the portion at which the metal portion 140a and the insulation portion 150 are coupled to each other is increased, as compared with a case where the irregularity portion 141a does not exist, thereby solidifying the coupling between the insulation portion 150 and the metal portion 140a. Thus, the coupling between the insulation portion 150 and the metal portion 140a is solidified, so that it is possible to enhance the hardness of the case portion 130a and to improve the safety of the battery pack 100a. The irregularity portion 141a may be formed, for example, through a nano molding technology (NMT) process of alkali-treating, acid-treating, and then T-treating an SUS plate. The irregularity portion 141a formed by this process does not necessarily have a curved shape shown in FIG. 4 as an example. That is, the irregularity portion 141a may have a prismatic shape, or may not have a uniform shape as shown in FIG. 4. Although it has been illustrated in FIG. 4 that the irregularity portion 141a has only a protruded shape, this is provided for convenience of illustration. For example, the irregularity portion 141a may be implemented to have a rough surface including both protruded and recessed portions.

An edge portion 143a of the metal portion 140a may have a shape bent with respect to another region of the metal portion 140a. Accordingly, the hardness of the case portion 130a can be further enhanced. Specifically, the hardness K of the metal portion 140a is as follows.

$$K = \sum EI = \frac{\sum {Ebh}^{3}}{l 2}$$

Where E is the Young's modulus of the material of the metal portion 140a, b is a width of the edge portion 143a of the metal portion 140a, l is the length of the metal portion 140a, and h is a height of the edge portion of the metal portion 140a. Thus, the edge portion 143a of the metal portion 140a is bent so that the height h of the edge portion 143a is increased, thereby enhancing the hardness or rigidity of the metal portion 140a.

The insulation portion 150a is a member that insulates the case portion 130a from the bare cell 110 and the case portion 130a from the outside by covering at least one portion of the metal portion 140a. Here, the insulation portion 150 may cover the inner portion 142 and the edge portion 143a of the metal portion 140a. That is, the insulation portion 150 may include the inner insulation portion 151 covering the inner portion 142 of the metal portion 140a and an edge insulation portion 152 covering the edge portion 143a of the metal portion 140a. The protective circuit module 120 may be positioned on the inner insulation portion 151 to prevent a short circuit between the protective circuit module 120 and the metal portion 140a. The edge insulation portion 152 can enhance the hardness of the case portion 130a and prevent an undesired short circuit of the bare cell 110 and the case portion 130 with the outside. Thus, it is possible to improve the safety of the battery pack 100a.

The bare cells 110 may be accommodated in the case portion 130a. Specifically, the bare cells 110 may be respectively accommodated in the first and second regions 131 and 132 divided by the inner insulation portion 151. The protective circuit module 120 may be positioned on the inner insulation portion 151 so as to be connected to each bare cell 110.

As battery packs have reduced thickness and surface area, requirements for a thin and small case portion accommodating bare cells therein have been recently made. However, in a case where the case portion is simply configured with only an insulation material such as plastic, the thickness of the case portion is limited due to characteristics of injection molding, and therefore, it is difficult to implement a thin battery pack. Although the thin battery pack is manufactured, the hardness of the battery pack is very weak. In a case where the case portion is simply configured with only metal, it is difficult to implement the insulation structure of the battery pack.

However, the case portion 130a according to this embodiment includes both the metal portion 140a and the insulation portion 150 made of, for example, an insulation material such as plastic, so that the hardness of the case portion 130a can be secured to a certain level or more while implementing the thin battery pack. Further, it is possible to easily implement the insulation structure of the battery pack. Specifically, the case portion 130a according to this embodiment may include the metal portion 140a and the insulation portion 150 covering at least one portion of the metal portion 140a. In this case, the insulation structure of the insulation portion 150 can be easily implemented using an insert injection molding method. Since the case portion 130a includes the metal portion 140a that can secure hardness to a certain level even though the thickness of the case portion 130a is thin, it is possible to improve both the hardness and safety of the case portion 130a while implementing the thin case portion 130a.

FIG. 6 illustrates a perspective view showing a metal portion 140b of a battery pack according to another embodiment. Hereinafter, the metal portion 140b of the battery pack according to this embodiment will be described with reference to FIG. 6. In this embodiment, components identical or corresponding to those of the aforementioned embodiment are designated by like reference numerals, and descriptions overlapping with those of the aforementioned embodiment will be omitted.

In the battery pack according to this embodiment, a plurality of coupling elements 144 may be formed in an edge portion 143b of the metal portion 140b. Thus, a portion of the edge insulation portion 152 formed through injection molding can fill in the coupling elements 144 and, accordingly, the coupling between the edge insulation portion 152 and the edge portion 143b of the metal portion 140 can be further solidified. As a result, the safety of the battery pack employing the coupling elements 144 can be further improved. Although the coupling elements 144 illustrated in FIG. 6 have an open shape, i.e., are holes, it will be apparent to those of ordinary skill in the art that the coupling element 144 may be formed of any configuration that increases a surface area or contact relative to a smooth surface, e.g., a groove shape.

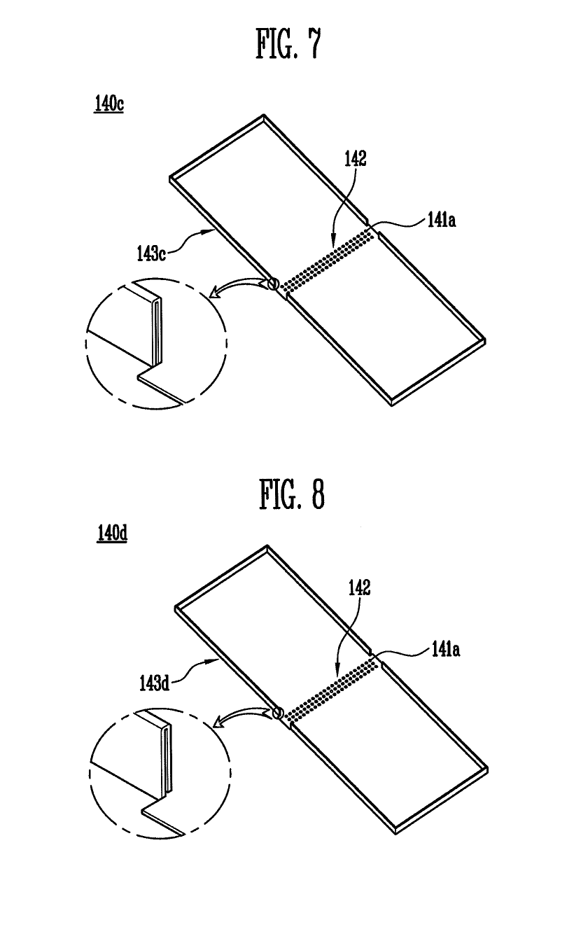

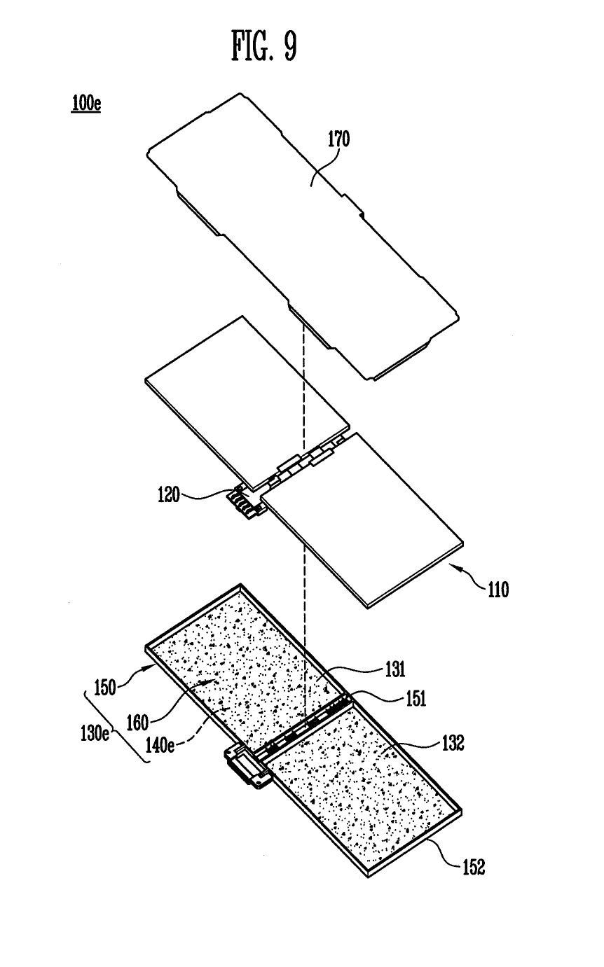

FIGS. 7 and 8 illustrate perspective views of metal portions 140c and 140d of the battery pack according to still other embodiments. Hereinafter, the metal portions 140c and 140d of the battery pack according to these embodiments will be described with reference to FIGS. 7 and 8. In these embodiments, components identical or corresponding to those of the aforementioned embodiment are designated by like reference numerals, and descriptions overlapping with those of the aforementioned embodiment will be omitted.

The metal portion 140c or 140d of the battery pack according to this embodiment may have an edge portion 143c or 143d bent two times or more. The edge portion 143c shown in FIG. 7 is bent towards the outside of the metal portion 140c, i.e., away from the battery cell 110. The edge portion 143d as shown in FIG. 8 is bent inward towards the inside of the metal portion 140d, i.e., towards the battery cell 110. When the edge portion 143c or 143d of the metal portion 140c or 140d is bent two or more times as shown in FIG. 8, the width b of the edge portion 143c or 143d may be entirely increased, so that the hardness of the metal portion 140c and 140d can be further enhanced. Thus, the hardness of the entire case portion is enhanced, and accordingly, the safety of the battery pack can be further improved.

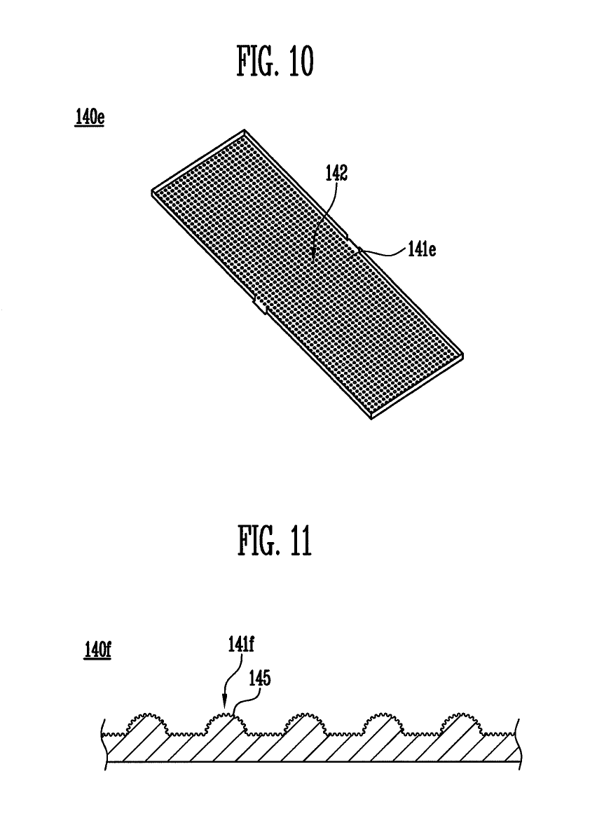

FIG. 9 is an exploded perspective view of a battery pack 100e according to still another embodiment. FIG. 10 is a perspective view showing a metal portion 140e of the battery pack 100e shown in FIG. 9. Hereinafter, the battery pack 100e according to this embodiment will be described with reference to FIGS. 9 and 10. In this embodiment, components identical or corresponding to those of the aforementioned embodiment are designated by like reference numerals, and descriptions overlapping with those of the aforementioned embodiment will be omitted.

As shown in FIGS. 9 and 10, the battery pack 100e according to this embodiment includes the bare cell 110 and a case portion 130e. The irregularity portion 141e may be formed on the entire surface of the metal portion 140e of the case portion 130e. That is, in the aforementioned embodiment, the irregularity portion 141a is formed at only the inner portion 142 of the metal portion 140a contacting the insulation member 150. In this embodiment, the irregularity portion 141e may also be formed at the metal portion 140e not contacting the insulation portion 150.

The case portion 130e of the battery pack 100e according to this embodiment may further include an insulation treatment layer 160. In this case, the insulation treatment layer 160 is not covered by the insulation portion 150 in the case portion 130e but positioned on the metal portion 140e exposed to the outside. In a case where the irregularity portion 141e is formed on the entire surface of the metal portion 140e, a portion of the insulation treatment layer 160 fills in a recessed portion of the irregularity portion 141e of the metal portion 140e exposed to the outside, thereby solidifying the coupling between the insulation treatment layer 160 and the metal portion 140e. Further, the portion of the insulation treatment layer 160 is filled in the irregularity portion 141e, so that it is possible to enhance the hardness of the entire case portion 130e, thereby improving the safety of the battery pack 100e. The insulation treatment layer 160 may be formed by performing spray injection or stacking a film such as a PI tape. The insulation between the case portion 130e and the bare cell 110 can be performed by the insulation treatment layer 160, and it is possible to prevent an undesired short circuit of the case portion 130e with the outside.

FIG. 11 illustrates a schematic enlarged view of an irregularity portion 141f of a metal portion 140f in a battery pack according to still another embodiment. The battery pack according to this embodiment will be described with reference to FIG. 11. In this embodiment, components identical or corresponding to those of the aforementioned embodiment are designated by like reference numerals, and descriptions overlapping with those of the aforementioned embodiment will be omitted.

As shown in FIG. 11, in the battery pack according to this embodiment, a plurality of prominences 145 may be provided to the irregularity portion 141f of the metal portion 140f. In this case, the surface area of the portion at which the metal portion 140f and the inner insulation portion 151 and/or the insulation treatment layer 160 are coupled to each other may be widened, as compared with a case where only the irregularity portion 141f exists. Accordingly, the coupling between the metal portion 140f and the inner insulation portion 151 and/or the insulation treatment layer 160 may be further improved. Thus, the hardness of the case portion may be further enhanced. As a result, the thickness of the metal portion 140f may be decreased, so that it is possible to the safety of the battery pack while implementing the thin case portion.

By way of summation and review, embodiments provide a battery pack that is lightweight and small, while having an excellent safety by employing a new structure. In particular, according to the battery pack of embodiments, the case portion includes a metal portion and an insulation portion covering at least one portion of the metal portion, so that it is possible for the case portion to become thinner and to enhance the hardness of the case portion, thereby improving the safety of the battery pack.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery pack, comprising:
a bare cell; and
a case portion accommodating the bare cell therein, the case portion including a metal portion and an insulation portion covering at least one portion of the metal portion, wherein the metal portion includes an irregularity portion.

2. The battery pack as claimed in claim 1, wherein the irregularity portion is formed in a region of the metal portion contacting the insulation portion.

3. The battery pack as claimed in claim 2, wherein the insulation portion is coupled to the metal portion so that at least one portion of the insulation portion fills in the irregularity portion of the metal portion.

4. The battery pack as claimed in claim 1, wherein the insulation portion includes an inner insulation portion covering an inner portion of the metal portion and an edge insulation portion covering an edge portion of the metal portion.

5. The battery pack as claimed in claim 4, further comprising a protective circuit module connected to the bare cell and mounted on the inner insulation portion.

6. The battery pack as claimed in claim 4, wherein the irregularity portion is formed at the inner portion of the metal portion.

7. The battery pack as claimed in claim 4, wherein the edge portion of the metal portion is bent.

8. The battery pack as claimed in claim 7, wherein the edge portion is bent two or more times.

9. The battery pack as claimed in claim 8, wherein the edge portion is bent towards the battery cell.

10. The battery pack as claimed in claim 8, wherein the edge portion is bent away from the battery cell.

11. The battery pack as claimed in claim 7, wherein a plurality of coupling elements is formed in the edge portion, and the edge insulation portion covers the edge portion so that at least one portion of the edge portion fills in the coupling elements.

12. The battery pack as claimed in claim 7, wherein the coupling elements are holes.

13. The battery pack as claimed in claim 1, wherein a plurality of prominences is formed on the irregularity portion.

14. The battery pack as claimed in claim 1, wherein the case portion further includes an insulation treatment layer on the metal portion exposed to the outside.

15. The battery pack as claimed in claim 14, wherein the insulation treatment layer is coupled to the metal portion so that at least one portion of the insulation treatment layer fills in the irregularity portion of the metal portion.

16. The battery pack as claimed in claim 1, wherein the insulation portion is an injection molded portion.
